(19) United States
(12) Patent Application Publication
(10) Pub. No.: US 2024/0146407 A1
(43) Pub. Date: May 2, 2024

(54) METHOD AND DEVICE FOR HANDOVER IN EMB-BASED NON-TERRESTRIAL NETWORK

(71) Applicants: HYUNDAI MOTOR COMPANY, Seoul (KR); KIA CORPORATION, Seoul (KR); INHA UNIVERSITY RESEARCH AND BUSINESS FOUNDATION, Incheon (KR)

(72) Inventors: Young Kil Suh, Hwaseong-si (KR); Gene Back Hahn, Hwaseong-si (KR); Ui Hyun Hong, Hwaseong-si (KR); Duk Kyung Kim, Seoul (KR)

(73) Assignees: HYUNDAI MOTOR COMPANY, Seoul (KR); KIA CORPORATION, Seoul (KR); INHA University Research and Business Foundation, Incheon (KR)

(21) Appl. No.: 18/405,818

(22) Filed: Jan. 5, 2024

Related U.S. Application Data
(63) Continuation of application No. PCT/KR2022/009775, filed on Jul. 6, 2022.

(30) Foreign Application Priority Data
Jul. 7, 2021 (KR) 10-2021-0089225

(51) Int. Cl. H04B 7/185

(52) U.S. Cl. CPC H04B 7/18541

(57) ABSTRACT

A method and a device for handover in an earth-moving beam (EMB)-based non-terrestrial network are disclosed. A method of a user equipment (UE) comprises the steps of: receiving, from a first cell of a satellite, first handover configuration information including information about a first cell service timer indicating the time at which a communication service can be provided in the first cell; reducing the first cell service timer according to a first reduction interval; and triggering an intra-satellite (intra-SAT) handover procedure if the first cell service timer has a first critical value or less.

### TECHNICAL FIELD

The present disclosure relates to a handover technique in a non-terrestrial network, and more particularly, to an intra-satellite (SAT) handover technique and an inter-SAT handover technique in an earth-moving beam (EMB)-based non-terrestrial network.

### BACKGROUND ART

In order to provide enhanced communication services, a communication system (e.g. 5G communication network, 6G communication network, etc.) using a higher frequency band (e.g. a frequency band of 6GHz or above) than a frequency band (e.g. a frequency band of 6GHz or below) of the long term evolution (LTE) communication system (or, LTE-A communication system) is being considered. The 5G communication network (e.g. new radio (NR) communication network) may support not only a frequency band of 6 GHz or below, but also a frequency band of 6 GHz or above, and may support various communication services and scenarios compared to the LTE communication network. For example, usage scenarios of the 5G communication network may include enhanced Mobile BroadBand (eMBB), Ultra Reliable Low Latency Communication (URLLC), Massive Machine Type Communication (mMTC), and the like. In addition, in order to provide enhanced communication services compared to the 5G communication network, the 6G communication network may support various and wide frequency bands and may be applied to various usage scenarios (e.g. terrestrial communication, non-terrestrial communication, sidelink communication, and the like).

The communication network (e.g. 5G communication network, 6G communication network, etc.) may provide communication services to terminals located on the ground. Recently, the demand for communication services for not only terrestrial but also non-terrestrial airplanes, drones, and satellites has been increasing, and for this purpose, technologies for a non-terrestrial network (NTN) have been discussed. The non-terrestrial network may be implemented based on 5G communication technology, 6G communication technology, and/or the like. For example, in the non-terrestrial network, communication between a satellite and a terrestrial communication node or a non-terrestrial communication node (e.g. airplane, drone, or the like) may be performed based on 5G communication technology, 6G communication technology, and/or the like. In the NTN, the satellite may perform functions of a base station in a communication network (e.g. 5G communication network, 6G communication network, and/or the like).

Meanwhile, a handover procedure based on reference signal received power (RSRP) may be performed in a terrestrial network (TN). Although communication services are provided over a wide area in an NTN due to the high altitude of a satellite, the variation in RSRP in that area may be relatively small. Due to the random characteristics of a channel in the NTN, the RSRP-based handover procedure may be executed differently from the handover procedure in the TN. Additionally, in the NTN, configuring cell coverage precisely based on reception quality alone (e.g. RSRP, reference signal received quality (RSRQ)) may be challenging.

It is anticipated that the effectiveness of a conditional handover (CHO) procedure will increase in the NTN due to a long channel delay. However, since the CHO procedure is performed based on RSRP, improvements to the CHO procedure may be necessary. In an EMB-based NTN, it is necessary to distinguish and perform an intra-SAT handover and inter-SAT handover.

### SUMMARY

The present disclosure is directed to providing a method and an apparatus for handover in a non-terrestrial network.

A method of a user equipment (UE), according to a first exemplary embodiment of the present disclosure for achieving the above-described objective, may comprise: receiving, from a first cell of a satellite, first handover configuration information including information on a first cell service timer indicating a time during which communication services can be provided by the first cell; decreasing the first cell service timer according to a first decrement interval; and in response to that the first cell service timer is equal to or less than a first threshold, triggering an intra-satellite (SAT) handover procedure.

The first handover configuration information may further include at least one of information on the first decrement interval or information on the first threshold.

The method may further comprise: receiving, from the first cell of the satellite, second handover configuration information including information on a SAT service timer indicating a time during which the communication services can be provided by the satellite; and decreasing the SAT service timer according to a second decrement interval, wherein when the first cell service timer is equal to or less than the first threshold and the SAT service timer exceeds a second threshold, the intra-SAT handover procedure is triggered.

The second handover configuration information may further include at least one of information on the second decrement interval or information on the second threshold.

The first cell service timer may start after the UE is connected to the first cell, and the SAT service timer may start after the UE is connected to the satellite.

The method may further comprise: receiving, from the first cell of the satellite, variable measurement configuration information; and in response to that the first cell service timer is equal to or less than the first threshold, performing variable measurement procedures instead of general measurement procedures based on the variable measurement configuration information, wherein a measurement periodicity for the variable measurement procedures is shorter than a measurement periodicity for the general measurement procedures.

The triggering of the intra-SAT handover procedure may comprise: in response to that the first cell service timer is equal to or less than the first threshold and an event for a handover from the first cell to a second cell of the satellite occurs, transmitting a handover initiation message including information on the second cell to the first cell; and receiving a handover command message from the first cell.

The method may further comprise: performing a connection establishment procedure with the second cell, wherein in the connection establishment procedure, third handover configuration information including information on a second cell service timer of the second cell is received.

A method of a user equipment (UE), according to a second exemplary embodiment of the present disclosure for achieving the above-described objective, may comprise: receiving, from a first satellite, first handover configuration information including information on a first satellite (SAT) service timer indicating a time during which communication services can be provided by the first satellite; decreasing the first SAT service timer according to a first decrement interval; and in response to that the first SAT service timer is equal to or less than a first threshold, triggering an inter-SAT handover procedure.

The first handover configuration information may further include at least one of information on the first decrement interval or information on the first threshold.

The method may further comprise: receiving, from the first satellite, second handover configuration information including information on a cell service timer indicating a time during which the communication services can be provided by a cell of the first satellite; and decreasing the cell service timer according to a second decrement interval, wherein when the first SAT service timer is equal to or less than the first threshold and the cell service timer is equal to or less than a second threshold, the inter-SAT handover procedure is triggered.

The second handover configuration information may further include at least one of information on the second decrement interval or information on the second threshold.

The method may further comprise: receiving, from the first satellite, variable measurement configuration information; and in response to that the first SAT service timer is equal to or less than the first threshold, performing variable measurement procedures instead of general measurement procedures based on the variable measurement configuration information, wherein a measurement periodicity for the variable measurement procedures is shorter than a measurement periodicity for the general measurement procedures.

The triggering of the inter-SAT handover procedure may comprise: in response to that the first SAT service timer is equal to or less than the first threshold and an event for a handover from the first satellite to a second satellite occurs, transmitting a handover initiation message including information on the second satellite to the first satellite; and receiving a handover command message from the first satellite.

The method may further comprise: performing a connection establishment procedure with the second satellite, wherein in the connection establishment procedure, third handover configuration information including information on a second SAT service timer of the second satellite is received.

A method of a first satellite, according to a third exemplary embodiment of the present disclosure for achieving the above-described objective, may comprise: transmitting, to a user equipment (UE), first handover configuration information including information on a first cell service timer indicating a time during which communication services can be provided by a first cell of the first satellite; receiving, from the UE, a first handover initiation message for an intra-satellite (SAT) handover procedure triggered based on the first handover configuration information; and in response to that the intra-SAT handover procedure from the first cell to a second cell of the first satellite is approved, transmitting a first handover command message to the UE.

The method may further comprise: performing a connection establishment procedure between the second cell and the UE, wherein in the connection establishment procedure, second handover configuration information including information on a second cell service timer indicating a time during which communication services can be provided by the second cell is transmitted to the UE.

The first cell service timer and the second cell service timer may be configured independently.

The method may further comprise: transmitting, to the UE, third handover configuration information including information on a SAT service timer indicating a time during which communication services can be provided by the first satellite; receiving, from the UE, a second handover initiation message for an inter-SAT handover procedure triggered based on the third handover configuration information; and in response to that the inter-SAT handover procedure from the first satellite to the second satellite is approved, transmitting a second handover command message to the UE.

The method may further comprise: transmitting variable measurement configuration information to the UE, wherein variable measurement procedures are performed by the UE instead of normal measurement procedures when a preconfigured condition is satisfied, and a measurement periodicity for the variable measurement procedures is shorter than a measurement periodicity for the general measurement procedures.

According to the present disclosure, a satellite may configure timer(s) for an intra-SAT handover procedure and/or an inter-SAT handover procedure in a UE. The UE may trigger each of the intra-SAT handover procedure and inter-SAT handover procedure based on the timer(s). Additionally, measurement procedures may be variably performed by the UE based on the timer(s). Accordingly, the handover procedures and measurement procedures in the NTN can be performed efficiently, leading to an improvement in the performance of the NTN.

### DESCRIPTION OF DRAWINGS

FIG. 1A is a conceptual diagram illustrating a first exemplary embodiment of a non-terrestrial network.

FIG. 1B is a conceptual diagram illustrating a second exemplary embodiment of a non-terrestrial network.

FIG. 2A is a conceptual diagram illustrating a third exemplary embodiment of a non-terrestrial network.

FIG. 2B is a conceptual diagram illustrating a fourth exemplary embodiment of a non-terrestrial network.

FIG. 2C is a conceptual diagram illustrating a fifth exemplary embodiment of a non-terrestrial network.

FIG. 3 is a block diagram illustrating a first exemplary embodiment of an entity constituting a non-terrestrial network.

FIG. 4A is a conceptual diagram illustrating a first exemplary embodiment of a protocol stack of a user plane in a transparent payload-based non-terrestrial network.

FIG. 4B is a conceptual diagram illustrating a first exemplary embodiment of a protocol stack of a control plane in a transparent payload-based non-terrestrial network.

FIG. 5A is a conceptual diagram illustrating a first exemplary embodiment of a protocol stack of a user plane in a regenerative payload-based non-terrestrial network.

FIG. 5B is a conceptual diagram illustrating a first exemplary embodiment of a protocol stack of a control plane in a regenerative payload-based non-terrestrial network.

FIG. 6A is a conceptual diagram illustrating a measurement result of reference signal received powers (RSRPs) in a terrestrial network.

FIG. 6B is a conceptual diagram illustrating a measurement result of RSRPs in a non-terrestrial network.

FIG. 7 illustrates an exemplary embodiment of a path according to a position of a UE within a beam coverage of a satellite.

FIG. 8 is a conceptual diagram illustrating changes in a coverage and a footprint of a satellite supporting multiple beams.

FIG. 9A is a sequence chart illustrating a first exemplary embodiment of a communication method in NTN.

FIG. 9B is a sequence chart illustrating a second exemplary embodiment of a communication method in NTN.

### DETAILED DESCRIPTION

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re)transmission” may refer to “transmission”, “retransmission”, or “transmission and retransmission”, “(re)configuration” may refer to “configuration”, “reconfiguration”, or “configuration and reconfiguration”, “(re)connection” may refer to “connection”, “reconnection”, or “connection and reconnection”, “(re)access” may mean “access”, “re-access”, or “access and re-access”, and “(re)selection” may mean “selection”, “reselection”, or “selection and reselection”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the present disclosure. As used herein, the singular forms are intended to include the plural forms as well, unless the context clearly indicates otherwise. It will be further understood that the terms “comprise” and/or “include” when used herein, specify the presence of stated features, integers, steps, operations, elements, components or combinations thereof, but do not preclude the presence or addition of one or more other features, integers, steps, operations, elements, components, and/or combinations thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted. In addition to the exemplary embodiments explicitly described in the present disclosure, operations may be performed according to a combination of the exemplary embodiments, extensions of the exemplary embodiments, and/or modifications of the exemplary embodiments. Performance of some operations may be omitted, and the order of performance of operations may be changed.

Even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a user equipment (UE) is described, a base station corresponding to the UE may perform an operation corresponding to the operation of the UE. Conversely, when an operation of a base station is described, a UE corresponding to the base station may perform an operation corresponding to the operation of the base station. In a non-terrestrial network (NTN) (e.g. payload-based NTN), operations of a base station may refer to operations of a satellite, and operations of a satellite may refer to operations of a base station.

The base station may refer to a NodeB, evolved NodeB (eNodeB), next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and/or the like. The UE may refer to a terminal, device, apparatus, node, communication node, end node, access terminal, mobile terminal, station, subscriber station, mobile station, portable subscriber station, on-broad unit (OBU), and/or the like.

In exemplary embodiments, signaling may be at least one of higher layer signaling, medium access control (MAC) signaling, or physical (PHY) signaling. Messages used for higher layer signaling may be referred to as ‘higher layer messages’ or ‘higher layer signaling messages’. Messages used for MAC signaling may be referred to as ‘MAC messages’ or ‘MAC signaling messages’. Messages used for PHY signaling may be referred to as ‘PHY messages’ or ‘PHY signaling messages’. The higher layer signaling may refer to a transmission and reception operation of system information (e.g. master information block (MIB), system information block (SIB)) and/or RRC messages. The MAC signaling may refer to a transmission and reception operation of a MAC control element (CE). The PHY signaling may refer to a transmission and reception operation of control information (e.g. downlink control information (DCI), uplink control information (UCI), and sidelink control information (SCI)).

In exemplary embodiments, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”.

A communication system may include at least one of a terrestrial network, non-terrestrial network, 4G communication network (e.g. long-term evolution (LTE) commu nication network), 5G communication network (e.g. new radio (NR) communication network), or 6G communication network. Each of the 4G communications network, 5G communications network, and 6G communications network may include a terrestrial network and/or a non-terrestrial network. The non-terrestrial network may operate based on at least one communication technology among the LTE communication technology, 5G communication technology, or 6G communication technology. The non-terrestrial network may provide communication services in various frequency bands.

The communication network to which exemplary embodiments are applied is not limited to the content described below, and the exemplary embodiments may be applied to various communication networks (e.g. 4G communication network, 5G communication network, and/or 6G communication network). Here, a communication network may be used in the same sense as a communication system.

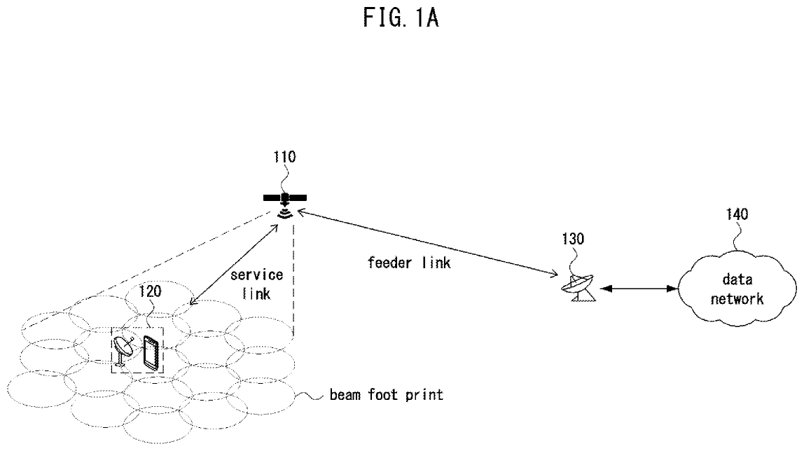

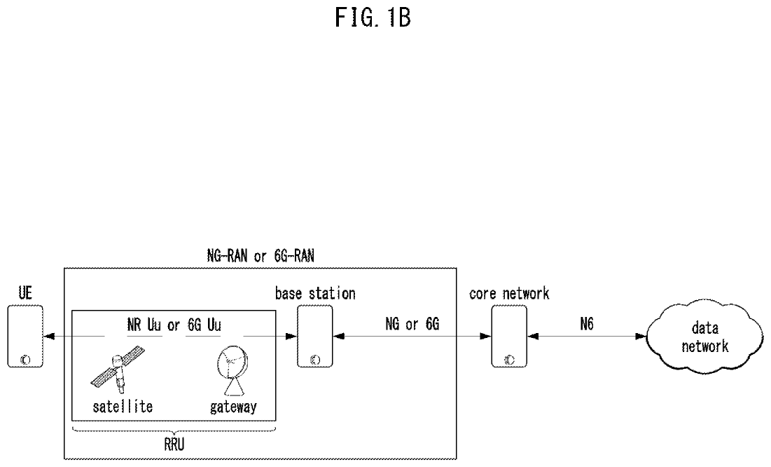

FIG. 1A is a conceptual diagram illustrating a first exemplary embodiment of a non-terrestrial network.

As shown in FIG. 1A, a non-terrestrial network (NTN) may include a satellite 110, a communication node 120, a gateway 130, a data network 140, and the like. A unit including the satellite 110 and the gateway 130 may correspond to a remote radio unit (RRU). The NTN shown in FIG. 1A may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS). A non-GEO satellite may be an LEO satellite and/or MEO satellite.

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical or circular.

The communication node 120 may perform communications (e.g. downlink communication and uplink communication) with the satellite 110 using 4G communication technology, 5G communication technology, and/or 6G communication technology. The communications between the satellite 110 and the communication node 120 may be performed using an NR-Uu interface and/or 6G-Uu interface. When dual connectivity (DC) is supported, the communication node 120 may be connected to other base stations (e.g. base stations supporting 4G, 5G, and/or 6G functionality) as well as the satellite 110, and perform DC operations based on the techniques defined in 4G, 5G, and/or 6G technical specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface, a 6G-Uu interface, or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the 4G communication technology, 5G communication technology, and/or 6G communication technology. For example, the core network may include an access and mobility management function (AMF), a user plane function (UPF), a session management function (SMF), and the like. The communications between the gateway 130 and the core network may be performed based on an NG-C/U interface or 6G-C/U interface.

As shown in an exemplary embodiment of FIG. 1B, there may be a ‘core network’ between the gateway 130 and the data network 140 in a transparent payload-based NTN.

FIG. 1B is a conceptual diagram illustrating a second exemplary embodiment of a non-terrestrial network.

As shown in FIG. 1B, the gateway may be connected with the base station, the base station may be connected with the core network, and the core network may be connected with the data network. Each of the base station and core network may support the 4G communication technology, 5G communication technology, and/or 6G communication technology. The communications between the gateway and the base station may be performed based on an NR-Uu interface or 6G-Uu interface, and the communications between the base station and the core network (e.g. AMF, UPF, SMF, and the like) may be performed based on an NG-C/U interface or 6G-C/U interface.

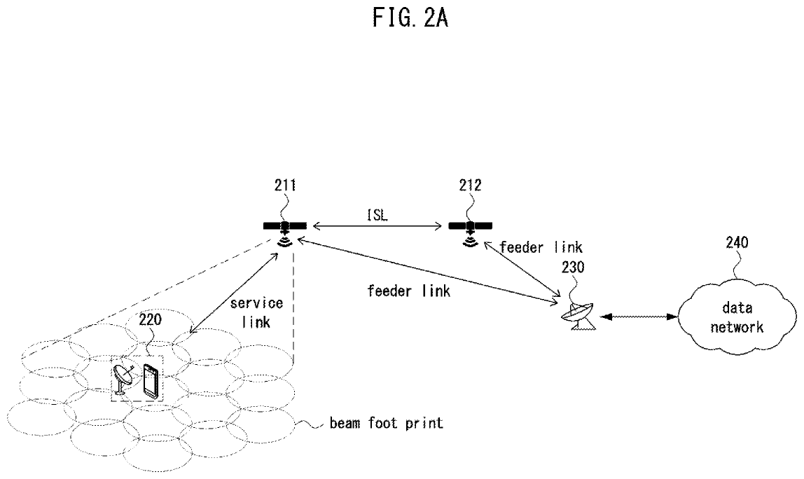

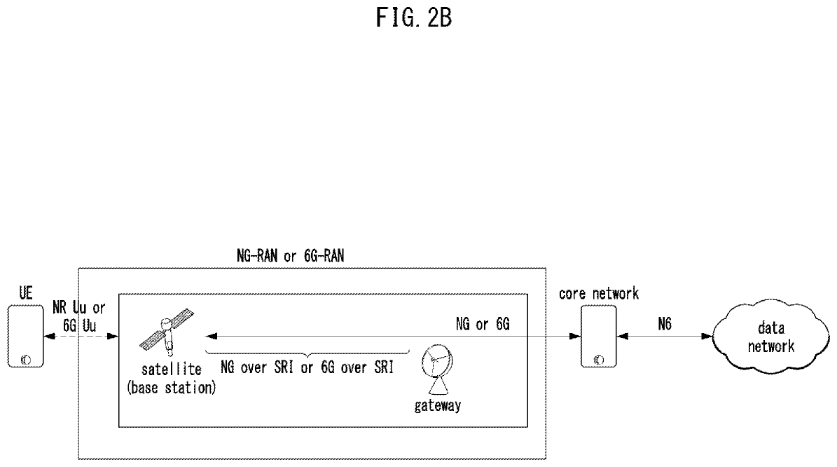

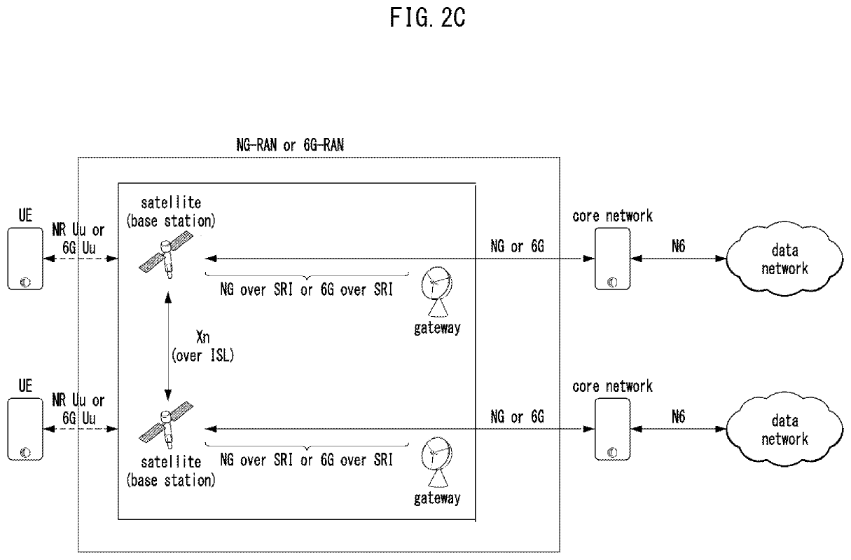

FIG. 2A is a conceptual diagram illustrating a third exemplary embodiment of a non-terrestrial network.

As shown in FIG. 2A, a non-terrestrial network may include a first satellite 211, a second satellite 212, a communication node 220, a gateway 230, a data network 240, and the like. The NTN shown in FIG. 2A may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink communication or uplink communication) with the satellite 211 using the 4G communication technology, 5G communication technology, and/or 6G communication technology. The communications between the satellite 211 and the communication node 220 may be performed using an NR-Uu interface or 6G-Uu interface. When DC is supported, the communication node 220 may be connected to other base stations (e.g. base stations supporting 4G, 5G, and/or 6G functionality) as well as the satellite 211, and may perform DC operations based on the techniques defined in 4G, 5G, and/or 6G technical specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily. The communications between each of the satellites 211 and 212 and the gateway 230 may be performed based on an NR-Uu interface, a 6G-Uu interface, or an SRI. The gateway 230 may be connected to the data network 240.

As shown in exemplary embodiments of FIG. 2B and FIG. 2C, there may be a ‘core network’ between the gateway 230 and the data network 240.

FIG. 2B is a conceptual diagram illustrating a fourth exemplary embodiment of a non-terrestrial network, and FIG. 2C is a conceptual diagram illustrating a fifth exemplary embodiment of a non-terrestrial network.

As shown in FIG. 2B and FIG. 2C, the gateway may be connected with the core network, and the core network may be connected with the data network. The core network may support the 4G communication technology, SG communication technology, and/or 6G communication technology. For example. The core network may include AMF, UPF, SMF, and the like. Communication between the gateway and the core network may be performed based on an NG-C/U interface or 6G-C/U interface. Functions of a base station may be performed by the satellite. That is, the base station may be located on the satellite. A payload may be processed by the base station located on the satellite. Base stations located on different satellites may be connected to the same core network. One satellite may have one or more base stations. In the non-terrestrial network of FIG. 2B, an ISL between satellites may not be established, and in the non-terrestrial network of FIG. 2C, an ISL between satellites may be established.

Meanwhile, the entities (e.g. satellite, base station, UE, communication node, gateway, and the like) constituting the non-terrestrial network shown in FIGS. 1A, 1B, 2A, 2B, and/or 2C may be configured as follows.

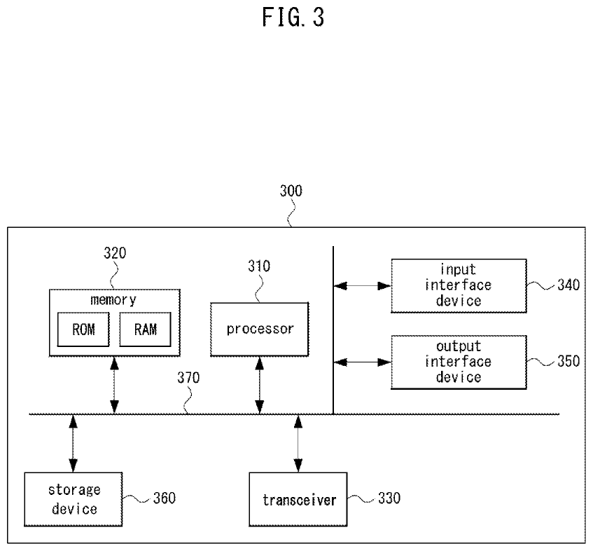

FIG. 3 is a block diagram illustrating a first exemplary embodiment of an entity constituting a non-terrestrial network.

As shown in FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, NTN reference scenarios may be defined as shown in Table 1 below.

TABLE 1

| | NTN shown in FIG. 1 | NTN shown in FIG. 2 |
|---|---|---|
| GEO | Scenario A | Scenario B |
| LEO (steerable | Scenario C1 | Scenario D1 |
| beams) | | |
| LEO (beams | Scenario C2 | Scenario D2 |
| moving with | | |
| satellite) | | |

When the satellite 110 in the NTN shown in FIG. 1A and/or FIG. 1B is a GEO satellite (e.g. a GEO satellite that supports a transparent function), this may be referred to as ‘scenario A’. When the satellites 211 and 212 in the NTN shown in FIG. 2A, FIG. 2B, and/or FIG. 2C are GEO satellites (e.g. GEOs that support a regenerative function), this may be referred to as ‘scenario B’.

When the satellite 110 in the NTN shown in FIG. 1A and/or FIG. 1B is an LEO satellite with steerable beams, this may be referred to as ‘scenario C1’. When the satellite 110 in the NTN shown in FIG. 1A and/or FIG. 1B is an LEO satellite having beams moving with the satellite, this may be referred to as ‘scenario C2’. When the satellites 211 and 212 in the NTN shown in FIG. 2A, FIG. 2B, and/or FIG. 2C are LEO satellites with steerable beams, this may be referred to as ‘scenario D1’. When the satellites 211 and 212 in the NTN shown in FIG. 2A, FIG. 2B, and/or FIG. 2C are LEO satellites having beams moving with the satellites, this may be referred to as ‘scenario D2’. Parameters for the scenarios defined in Table 1 may be defined as shown in Table 2 below.

Parameters for the NTN reference scenarios defined in Table 1 may be defined as shown in Table 2 below.

TABLE 2

| | Scenarios A and B | Scenarios C and D |
|---|---|---|
| Altitude | 35,786 km | 600 km |
| | | 1,200 km |
| Spectrum (service link) | <6 GHz (e.g. 2 GHz) | |
| | >6 GHz (e.g. DL 20 GHz, UL 30 GHz) | |
| Maximum channel | 30 MHz for band <6 GHz | |
| bandwidth capability | 1 GHz for band >6 GHz | |
| (service link) | | |
| Maximum distance | 40,581 km | 1,932 km (altitude of 600 |
| between satellite and | | km) |
| communication node (e.g. | | 3,131 km (altitude of |
| UE) at the minimum | | 1,200 km) |
| elevation angle | | |
| Maximum round trip | Scenario A: 541.46 ms | Scenario C: (transparent |
| delay (RTD) | (service and feeder links) | payload: service and |
| (only propagation delay) | Scenario B: 270.73 ms | feeder links) |
| | (only service link) | −5.77 ms (altitude of 60 |
| | | 0 km) |
| | | −41.77 ms (altitude of |
| | | 1,200 km) |
| | | Scenario D: (regenerative |
| | | payload: only service link) |
| | | −12.89 ms (altitude of 600 |
| | | km) |
| | | −20.89 ms (altitude of |
| | | 1,200 km) |
| Maximum differential | 10.3 ms | 3.12 ms (altitude of 600 |
| delay within a cell | | km) |
| | | 3.18 ms (altitude of 1,200 |
| | | km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario | Scenario | Scenario | | Scenario | |
|---|---|---|---|---|---|---|
| | A | B | C1-2 | | D1-2 | |
| Satellite altitude | 35,786 km | | 600 km | | | |
| Maximum RTD in a | 541.75 ms | 270.57 ms | 28.41 | ms | 12.88 | ms |
| radio interface | (worst case) | | | | | |
| between base | | | | | | |
| station and UE | | | | | | |
| Minimum RTD in a | 477.14 ms | 238.57 ms | 8 | ms | 4 | ms |
| radio interface | | | | | | |
| between base | | | | | | |
| station and UE | | | | | | |

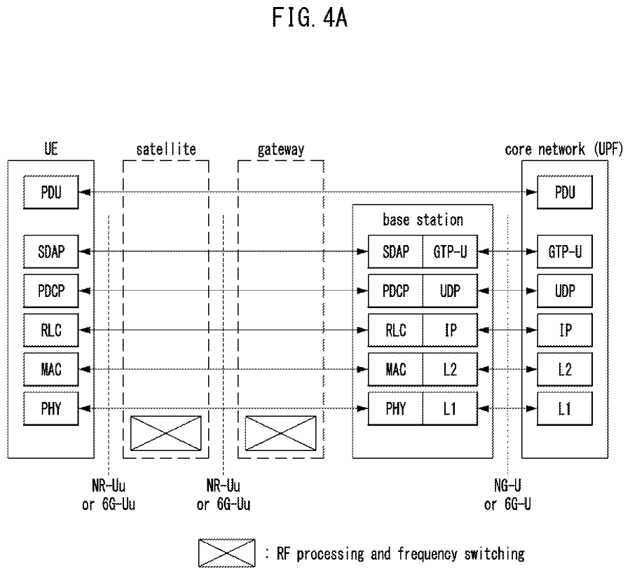

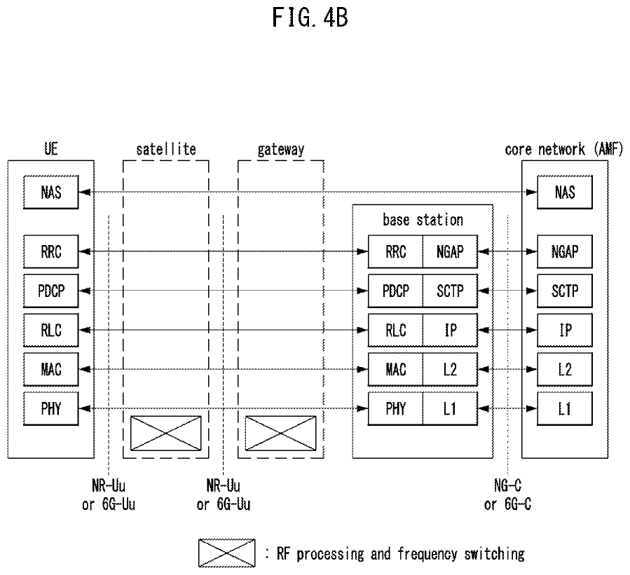

FIG. 4A is a conceptual diagram illustrating a first exemplary embodiment of a protocol stack of a user plane in a transparent payload-based non-terrestrial network, and FIG. 4B is a conceptual diagram illustrating a first exemplary embodiment of a protocol stack of a control plane in a transparent payload-based non-terrestrial network.

As shown in FIGS. 4A and 4B, user data may be transmitted and received between a UE and a core network (e.g. UPF), and control data (e.g. control information) may be transmitted and received between the UE and the core network (e.g. AMF). Each of the user data the and control data may be transmitted and received through a satellite and/or gateway. The protocol stack of the user plane shown in FIG. 4A may be applied identically or similarly to a 6G communication network. The protocol stack of the control plane shown in FIG. 4B may be applied identically or similarly to a 6G communication network.

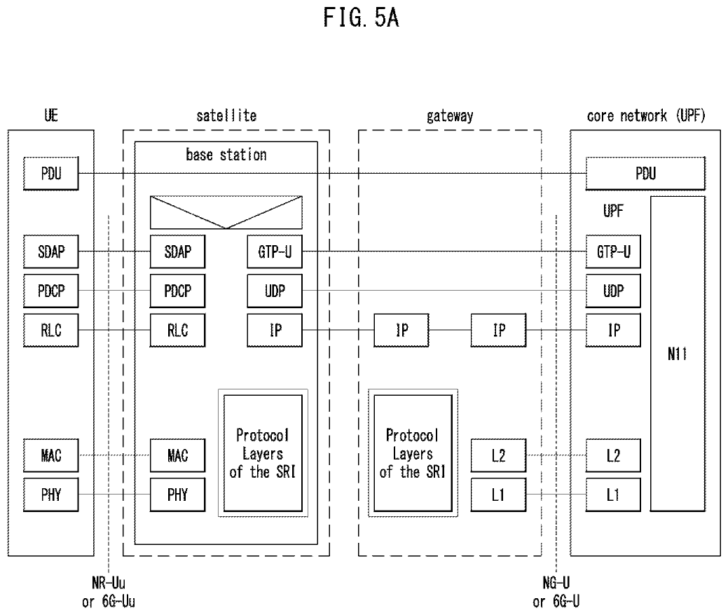

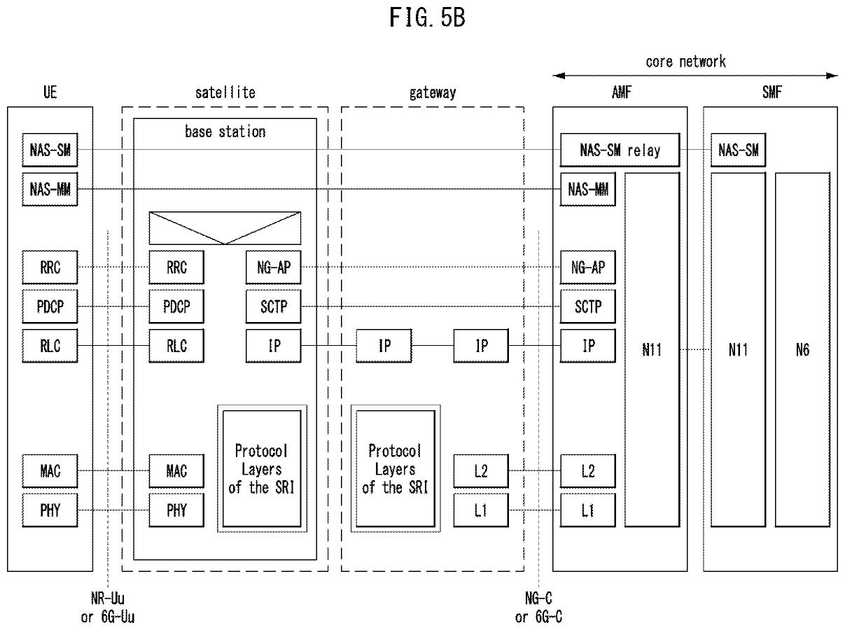

FIG. 5A is a conceptual diagram illustrating a first exemplary embodiment of a protocol stack of a user plane in a regenerative payload-based non-terrestrial network, and FIG. 5B is a conceptual diagram illustrating a first exemplary embodiment of a protocol stack of a control plane in a regenerative payload-based non-terrestrial network.

As shown in FIGS. 5A and 5B, each of user data and control data (e.g. control information) may be transmitted and received through an interface between a UE and a satellite (e.g. base station). The user data may refer to a user protocol data unit (PDU). A protocol stack of a satellite radio interface (SRI) may be used to transmit and receive the user data and/or control data between the satellite and a gateway. The user data may be transmitted and received through a general packet radio service (GPRS) tunneling protocol (GTP)-U tunnel between the satellite and a core network.

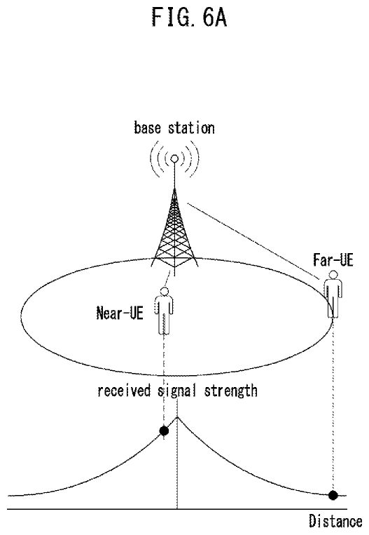

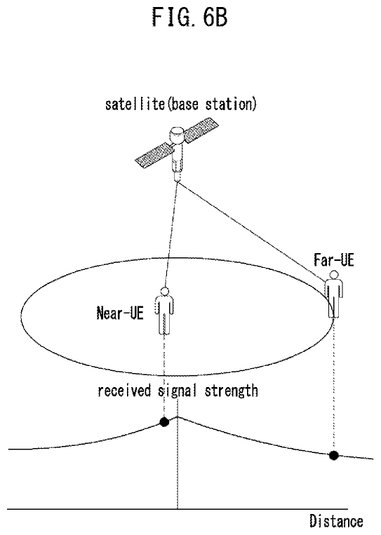

FIG. 6A is a conceptual diagram illustrating a measurement result of reference signal received powers (RSRPs) in a terrestrial network, and FIG. 6B is a conceptual diagram illustrating a measurement result of RSRPs in a non-terrestrial network.

As shown in FIG. 6A, a path loss exponent may be assumed to be 4, and differences in RSRP according to distances (e.g. 100 meters (m), 500 m, 1 kilometer (km), and 10 km) from a base station in a terrestrial network may be as shown in Table 4 below. A reference position may be represented as a distance from the base station to the corresponding reference position.

TABLE 4

Distance from a base station

| Reference position | 100 m | 500 m | 1 km | 10 km |
|---|---|---|---|---|
| 100 ms | 0 dB | −28 dB | −40 dB | −80 dB |
| 500 ms | — | 0 dB | −12 dB | −52 dB |
| 1 km | — | — | 0 dB | −40 dB |
| 10 km | — | — | — | 0 dB |

As shown in FIG. 6B, in a non-terrestrial network, a path loss exponent may be assumed to be 2, and a satellite may be a LEO satellite with an altitude of 600 km. In the non-terrestrial network, a difference in RSRP according to a distance (e.g. 10 km, 50 km, 100 km, 500 km) between a nadir and a UE may be shown in Table 5 below. A distance between the satellite and the UE, depending on the distance between the nadir and the UE, may be 600 km, 602 km, 608 km, or 781 km.

TABLE 5

| | | | | | | | | |
|---|---|---|---|---|---|---|---|---|
| Distance between nadir | 10 | km | 50 | km | 100 | km | 500 | km |
| and UE | | | | | | | | |
| Distance between the | 600 | km | 602 | km | 608 | km | 781 | km |
| satellite and the UE | | | | | | | | |
| Reference position | 0 | dB | 0 | dB | −0.1 | dB | −2.3 | dB |
| (10 km) | | | | | | | | |

In a satellite that supports multi-beam, if a cell radius is about 50 km, a difference in a path length may be small. A distance between the satellite and the UE at 500 km from the nadir is only 781 km, and a difference between an RSRP at 500 km from the nadir and an RSRP at 10 km from the nadir may be −2.3 dB.

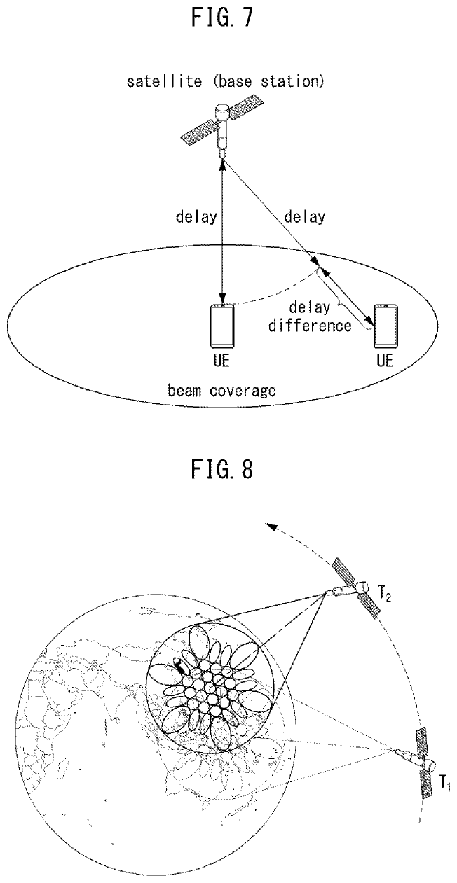

FIG. 7 illustrates an exemplary embodiment of a path according to a position of a UE within a beam coverage of a satellite.

As shown in FIG. 7, a difference (or delay difference) in a path between a satellite and a UE may occur depending on a position of the UE within the satellite's beam coverage (e.g. satellite coverage). The difference (or delay difference) in the path between the satellite (e.g. base station) and the UE according to the position of the UE in a non-terrestrial network may not be larger than a difference (or delay difference) in a path between a base station and a UE depending on a position of the UE in a terrestrial network.

A beam of a satellite may have earth moving beam (EMB) characteristics. In this case, a cell coverage on the ground may continuously change depending on a movement of the satellite. Accordingly, a remaining service time (i.e. cell service time) in a cell where a UE is located (e.g. remaining cell service time) may change depending on a location of the UE. The remaining service time may be a time during which communication services can be provided to the UE in the cell where the UE is located. If the UE leaves the current cell (e.g. serving cell) due to the movement of the satellite, the UE may need to perform a handover procedure to another cell.

FIG. 8 is a conceptual diagram illustrating changes in a coverage and a footprint of a satellite supporting multiple beams.

As shown in FIG. 8, a satellite may support EMB. One satellite may form a plurality of cells. The plurality of cells may be configured within a coverage (e.g. beam coverage) of the satellite. When the satellite moves, the coverage of the satellite or locations of the cells may change.

In an EMB-based NTN, at least one of a cell service time, which is a remaining service time in a cell, a cell service timer for the cell service time, a SAT service time, which is a remaining service time in a coverage of a satellite, or a SAT service timer for the SAT service time may be introduced. In the NTN, a handover procedure may be performed based on the cell service timer and/or SAT service timer. In the NTN, an intra-SAT handover procedure and an inter-SAT handover procedure may be distinguished. The intra-SAT handover procedure may be performed based on the cell service timer, and the inter-SAT handover procedure may be performed based on the SAT service timer. Each of the cell service timer and SAT service timer may be decreased according to a decrement interval. If the cell service timer is equal to or less than a threshold, the intra-SAT handover procedure may be triggered. If the SAT service timer is equal to or less than a threshold, the inter-SAT handover procedure may be triggered.

In addition, not only the cell service timer but also the SAT service timer may be considered for the intra-SAT handover procedure. Not only the SAT service timer but also the cell service timer may be considered for the inter-SAT handover procedure. The cell service timer and/or SAT service timer may operate inside the UE. In the NTN, a conditional handover (CHO) procedure may be performed based on the cell service timer and/or the SAT service timer. A base station (e.g. satellite) may configure a cell service timer and signal information on the cell service timer to a UE. Alternatively, the base station may signal an initial value of a cell service timer and/or information element(s) required to determine the cell service timer to the UE. The UE may receive the cell service timer, initial value of the cell service timer, and/or information element(s) required to determine the cell service timer from the base station.

The base station (e.g. satellite) may configure a SAT service timer and signal information of the SAT service timer to the UE. Alternatively, the base station may signal an initial value of the SAT service timer and/or information element(s) required to determine the SAT service timer to the UE. The UE may receive the SAT service timer, initial value of the SAT service timer, and/or information element(s) required to determine the SAT service timer from the base station.

Alternatively, the cell service timer and/or SAT service timer may be predefined in the technical specifications. In this case, the cell service timer and/or

SAT service timer may not be signaled by the base station. That is, the UE may use the predefined cell service timer and/or SAT service timer.

### Cell Service Timer

The cell service timer may be referred to as cTimer. . The cell service timer may be referred to as a cell expiration timer. The cell service timer may be a timer that defines a time (e.g. remaining time) during which communication services can be provided in the corresponding cell where the UE is located. The cell service timer may have the following characteristic(s).
The cell service timer may be an internal timer of the UE.
In the EMB-based NTN, the cell service timer may be configured UE-specifically.
The cell service timer may be configured for each satellite or cell. The cell service timers for different cells may be the same or different.
The cell service timer may be initialized when the UE enters the cell, when the UE is connected to the cell, or when the UE accesses the cell. That is, the cell service timer may be set to the initial value. Thereafter, the cell service timer may decrease at a preset decrement interval. A unit of the decrement interval may be a slot or millisecond. Alternatively, the unit of the decrement interval may be set in various ways. The decrement interval or the unit of the decrement interval may be determined depending on mobility of the UE and/or satellite.
The decrement interval at which the cell service timer decreases may be corrected in consideration of at least one of the UE's movement speed, UE's movement direction, satellite's movement speed, satellite's movement direction, satellite's type (e.g. LEO, MEO, GEO), or satellite's altitude. For example, a decrement interval when the satellite's movement direction and the UE's movement direction are the same (or similar) may be smaller than a decrement interval when the satellite's movement direction and the UE's movement direction are opposite.
The (initial) value of the cell service timer may be calculated based on at least one of information element(s) broadcast from the satellite, ephemeris information, the UE's location information (e.g. the UE's location information obtained through a global navigation satellite system (GNSS)), information on a distance from the UE to a center of the cell, or information on a type of the cell (e.g. cell-specific common cell service timer, cell radius, cell shape).
Additional information element(s) for calculating the initial value of the cell service timer may be broadcast through system information.
When the cell service timer expires (e.g. when the cell service timer becomes 0), it may be determined that a time during which a communication service can be provided in the cell where the UE is located has expired. To complement the accuracy of the cell service timer, reception quality information (e.g. RSRP, RSRQ, received signal strength indicator (RSSI)) may be used complementarily along with the cell service timer in a handover procedure (or, cell selection procedure).

### SAT Service Timer

A satellite (SAT) service timer may be referred to as sTimer. The SAT service timer may be referred to as a SAT expiration timer. The SAT service timer may be a timer that defines a time (e.g. remaining time) during which communication services can be provided in a coverage of a corresponding satellite where the UE is located. The SAT service timer may have the following characteristic(s).
The SAT service timer may be an internal timer of the UE.
In the EMB-based NTN, the SAT service timer may be configured UE-specifically.
The SAT service timer may be configured for each satellite. The SAT service timers for different satellites may be the same or different.
The SAT service timer may be initialized when the satellite starts providing communication services to the UE, when the UE is connected to the satellite, or when the UE accesses the satellite. That is, the SAT service timer may be set to an initial value. Thereafter, the SAT service timer may be decreased at a preset decrement interval. A time of initializing the SAT service timer may be a time after the UE receives system information from the satellite and connects to a specific cell among cells configured by the satellite. A unit of the decrement interval may be a slot or millisecond. Alternatively, the unit of the decrement interval may be set in various ways. The decrement interval or the unit of the decrement interval may be the same for UEs. Alternatively, the decrement interval or unit of the decrement interval may be determined depending on mobility of the UE and/or satellite. The SAT service timer may be initialized each time a cell (re)selection procedure or handover procedure is performed.
The decrement interval at which the SAT service timer decreases may be corrected in consideration of at least one of the UE's movement speed, UE's movement direction, satellite's movement speed, satellite's movement direction, satellite's type (e.g. LEO, MEO, GEO), or satellite's altitude. For example, a decrement interval when the satellite's movement direction and the UE's movement direction are the same (or similar) may be smaller than a decrement interval when the satellite's movement direction and the UE's movement direction are opposite.
The initial value of the SAT service timer may be calculated based on at least one of information element(s) broadcast from the satellite, ephemeris information, the UE's location information (e.g. the UE's location information obtained through a GNSS), information on a distance from the UE to a coverage center of the satellite, or information on a form of the coverage of the satellite (e.g. coverage radius, coverage shape).
Additional information element(s) for calculating the initial value of the SAT service timer may be broadcast through system information.
When the SAT service timer expires (e.g. when the SAT service timer becomes 0), it may be determined that a time during which communication services can be provided by the satellite where the UE is located has expired. To complement the accuracy of the SAT service timer, reception quality information (e.g. RSRP) may be used complementarily together with the SAT service timer in a handover procedure (or, cell selection procedure).

### Variable Measurement Procedure

In an LEO-based NTN, if a UE is handed over to a specific cell of a satellite (e.g. LEO satellite), a possibility that a connection between the UE and the specific cell is maintained for a predetermined time may be large considering an orbit and/or movement speed of the satellite. If a value of a cell service timer cTimer is large, a possibility of requesting handover in the NTN where the satellite's orbit is deterministic may be low. Therefore, a need for measurement procedures may be low. When the cell service timer is decreased, a possibility of handover increases, so it may be preferable for measurement procedures to be performed frequently. In an EMB-based NTN, in addition to the cell service timer, the SAT service timer sTimer may be additionally used. A measurement periodicity for the inter-SAT handover procedure may be adjusted based on the cell service timer and/or SAT service timer.

In the EMB-based NTN, a connection between the UE and the cell may be maintained for a time corresponding to the cell service timer (e.g. a time until the cell service timer becomes 0), and a connection between the UE and the satellite may be maintained for a time corresponding to the SAT service timer (e.g. a time until the SAT service timer becomes 0). It may be necessary for the measurement procedures to be performed taking into account the above-described operation plan of the satellite.

In the EMB-based NTN, the cell service time (e.g. cell service timer) and the SAT service time (e.g. SAT service timer) may be different. As the value of the cell service timer decreases, a time to perform an intra-SAT handover procedure may get closer. As the value of the SAT service timer decreases, a time to perform an inter-SAT handover procedure may get closer. In the NTN (e.g. EMB-based NTN), the measurement periodicity and/or the reporting periodicity of measurement results may be set variably based on the cell service timer and/or SAT service timer. In this case, the intra-SAT handover procedure and the inter-SAT handover procedure may be distinguished. In addition, the intra-SAT handover procedure and the inter-SAT handover procedure can be performed efficiently.

In the EMB-based NTN, the measurement periodicity and/or measurement reporting periodicity may be variably set based on at least one of the cell service timer or the SAT service timer. In this case, the performance of the measurement procedures for handover may not be degraded and the measurement overhead may be reduced. That is, the UE's power consumption due to unnecessary measurements can be reduced, and signaling overhead due to the measurement reports can be reduced.

The cell service timer may be assigned (e.g. set) at a time when the UE is handed over to a new cell (e.g. new serving cell, target cell). The SAT service timer may be assigned (e.g. set) at a time when the UE is handed over to a new satellite (e.g. new serving satellite, target satellite). A multi-beam-based satellite may form (e.g. configure) a plurality of cells. A value (e.g. setting value, initial value) of each of the cell service timer and the SAT service timer may vary depending on the location of the satellite, location of the cell, and/or location of the UE. A value (e.g. setting value, initial value) of each of the cell service timer and the SAT service timer may be calculated based on at least one of ephemeris information of the satellite, information related to the cell, or location information of the UE.

If the value of the cell service timer is equal to or less than a first threshold or if the value of the cell service timer is equal to or less than the first threshold and the value of the SAT service timer exceeds a second threshold, this may mean that an intra-SAT handover procedure (i.e. inter-cell handover procedure) needs to be performed. If the SAT service timer is equal to or less than the second threshold or if the cell service timer value is equal to or less than the first threshold and the value of the SAT service timer is equal to or less the second threshold, this may means that an inter-SAT handover procedure needs to be performed. The first threshold and the second threshold may be the same value. Alternatively, the first threshold value and the second threshold value may be different values. The base station may set each of the first and second thresholds, and signal each of the first and second thresholds to the UE.

Each of the measurement periodicity and measurement reporting periodicity may be set depending on a situation of the intra-SAT handover and/or inter-SAT handover. For example, the measurement periodicity may be set based on Equation 1 below. The measurement reporting periodicity (i.e. reporting periodicity of measurement results) may be set to be the same as the measurement periodicity.

measurement periodicity=20 msec×2ⁿ [Equation 1]

In Equation 1, n may be determined based on Equation 2 below.

$$n = ⌊ N \times f ( \frac{cTimer}{CTimer\_max} \cdot \frac{1}{sTimer} ) ⌋ \qquad [ Equation 2 ]$$

N, cTimer_max, and/or f(x) may be configured by the base station to the UE. Alternatively, N, cTimer_max, and/or f(x) may be predefined in the technical specifications. Alternatively, N, cTimer_max, and/or f(x) may be determined by the UE. cTimer_max may be the maximum value of the cell service timer. cTimer may be the value (e.g. current value) of the cell service timer. sTimer may be the value (e.g. current value) of the SAT service timer. N may be a natural number.

The UE may determine the measurement periodicity based on Equation 1 and Equation 2, identify the reception quality (e.g. RSRP, RSRQ, RSSI) of the satellite (e.g. base station) by performing measurement operations based on the measurement periodicity, and report the measurement results (e.g. reception quality) to the satellite (e.g. base station). The reporting periodicity of the measurement results may be set to be the same as or different from the measurement periodicity. In addition, the satellite may estimate the measurement periodicity and/or measurement reporting periodicity from the UE based on Equation 1 and Equation 2, and may receive measurement results from the UE based on the measurement periodicity and/or measurement reporting periodicity.

As another method, n in Equation 1 may be set based on Table 6 below. The satellite may signal the information of Table 6 to the UE. The UE may receive the information of Table 6 from the satellite. Alternatively, Table 6 may be predefined in the technical specifications. In Table 6, sTimer may be the value (e.g. current value) of the SAT service timer, and cTimer may be the value (e.g. current value) of the cell service timer.

TABLE 6

| | sTimer | | | | | | | |
|---|---|---|---|---|---|---|---|---|
| | 20 min | | | 10 min | | | | 20 msec |
| cTimer | 2 min | 1 min | 20 msec | 2 min | 1 min | 20 msex | | 20 msex |
| n | X1 | X2 | X3 | X4 | X5 | X6 | . . . | Xₖ |

The UE may determine the measurement periodicity based on Equation 1 and Table 6, identify the reception quality (e.g. RSRP, RSRQ, RSSI) of the satellite (e.g. base station) by performing measurement operations based on the measurement periodicity, and report the measurement results (e.g. reception quality) to the satellite (e.g. base station). The reporting periodicity of the measurement results may be set to be the same as or different from the measurement periodicity. In addition, the satellite may estimate the measurement periodicity and/or measurement reporting periodicity from the UE based on Equation 1 and Table 6, and may receive measurement results from the UE based on the measurement periodicity and/or measurement reporting periodicity.

A time of performing the measurement reporting procedure may be configured with an offset (hereinafter referred to as ‘reporting offset’) with respect to a time of performing the measurement procedure. The satellite may set a reporting offset and signal information on the reporting offset to the UE. The UE may receive the information on the reporting offset from the satellite. The UE may perform a measurement procedure and perform a measurement reporting procedure after the reporting offset from the time of performing the measurement procedure. The satellite may receive measurement results from the UE considering the reporting offset. Alternatively, the reporting offset may be predefined in the technical specifications. Alternatively, the reporting offset may be set by the UE.

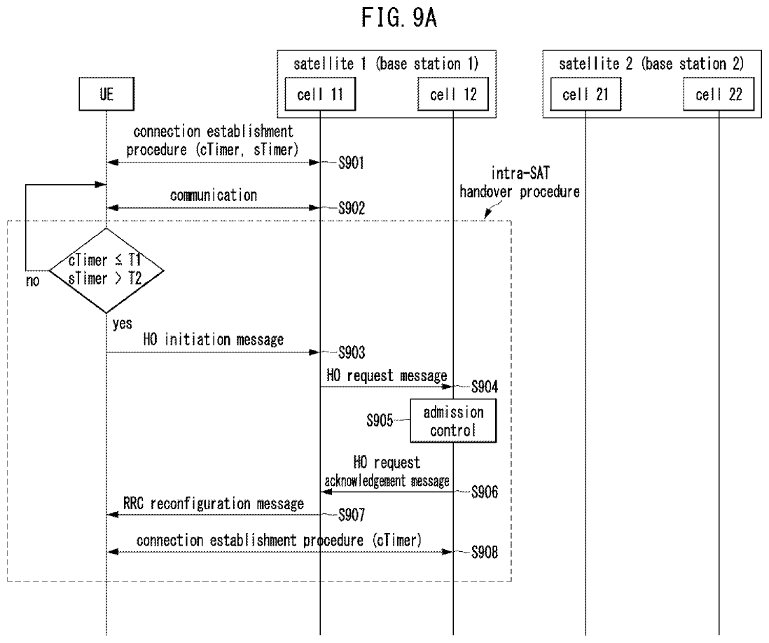

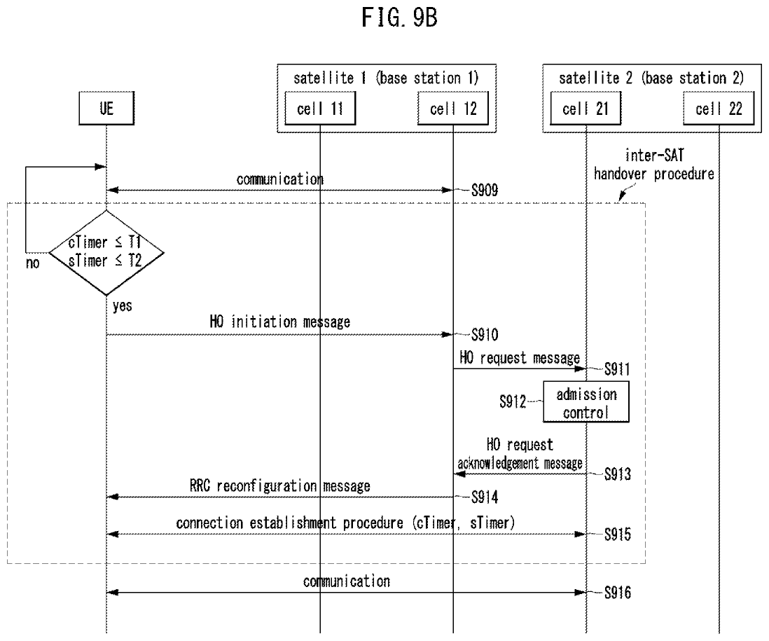

FIG. 9A is a sequence chart illustrating a first exemplary embodiment of a communication method in NTN, and FIG. 9B is a sequence chart illustrating a second exemplary embodiment of a communication method in NTN.

As shown in FIGS. 9A and 9B, an NTN may include a satellite 1, a satellite 2, and a UE. The satellite 1 may form a plurality of cells (e.g. cell 11 and cell 12) and may perform base station functions. That is, the satellite 1 may include a base station 1. The satellite 2 may form a plurality of cells (e.g. cell 21 and cell 22) and may perform base station functions. That is, the satellite 2 may include a base station 2. Operations of the cell may be operations of the base station and/or operations of the satellite. The exemplary embodiments of FIGS. 9A and/or 9B may be applied to a general handover procedure as well as a conditional handover procedure.

The UE may be connected to the satellite 1. That is, a connection establishment procedure between the UE and the satellite 1 may be performed (S901). The connection establishment procedure may mean an initial access procedure and may include a synchronization acquisition procedure between the UE and the satellite 1. In the connection establishment procedure between the UE and the satellite 1, the satellite 1 may transmit handover configuration information and/or measurement configuration information (e.g. variable measurement configuration information) to the UE. The UE may receive the handover configuration information and/or measurement configuration information from the satellite 1. The handover configuration information may include intra-SAT handover configuration information and/or inter-SAT handover configuration information. The intra-SAT handover configuration information may include one or more information elements defined in Table 7 below. The UE may identify cTimer, cTimer decrement interval, and/or cTimer threshold based on one or more information elements defined in Table 7 below. Alternatively, cTimer, cTimer decrement interval, and/or cTimer threshold may be predefined in the technical specifications. In this case, the UE may know cTimer, cTimer decrement interval, and/or cTimer threshold without signaling from the satellite 1.

TABLE 7
Information elements

cTimer (e.g. initial value, setting value, and/or maximum value of cTimer)
Parameter(s) for determining cTimer
Decrement interval of cTimer
Parameter(s) for determining the decrement interval of cTimer
cTimer threshold (e.g. first threshold T1)

The UE may identify sTimer, sTimer decrement interval, and/or sTimer threshold based on one or more information elements defined in Table 8 below. Alternatively, sTimer, sTimer decrement interval, and/or sTimer threshold may be predefined in the technical specifications. In this case, the UE may know sTimer, sTimer decrement interval, and/or sTimer threshold without signaling from the satellite 1.

TABLE 8
Information elements

sTimer (e.g. initial value, setting value, and/or maximum value of sTimer)
Parameter(s) for determining sTimer
Decrement interval of sTimer
Parameter(s) for determining the decrement interval of sTimer
sTimer threshold (e.g. second threshold T2)

The variable measurement configuration information may include one or more information elements defined in Table 9 below. The UE may identify the measurement periodicity and/or measurement reporting periodicity based on the one or more information elements defined in Table 9 below. Alternatively, the measurement periodicity and/or measurement reporting periodicity may be predefined in the technical specifications. In this case, the UE may know the measurement periodicity and/or measurement reporting periodicity without signaling from the satellite 1.

TABLE 9
Information elements

Measurement periodicity
Parameter(s) for determining measurement periodicity (e.g. n, N, and/or
cTimer_max in Equations 1 and 2)
Measurement reporting periodicity
Parameter(s) for determining measurement reporting periodicity

The measurement periodicity and/or measurement reporting periodicity defined in Table 9 may be used for variable measurement procedures. The variable measurement procedures may be distinguished from the general measurement procedures. The measurement periodicity for the variable measurement procedures may be shorter than that for the general measurement procedures. The measurement reporting periodicity for the variable measurement procedures may be shorter than the measurement reporting periodicity for the general measurement procedures. Configuration information for the general measurement procedures (e.g. measurement periodicity and/or measurement reporting periodicity) may be signaled in the connection establishment procedure between the UE and the satellite 1. The general measurement procedures may refer to relaxed measurement procedures.

The UE may measure received signal quality(ies) (e.g. RSRP, RSRQ, RSSI) for cell(s) and/or satellite(s) by performing the general measurement procedures. If a preconfigured condition is met, the UE may measure received signal quality(ies) (e.g. RSRP, RSRQ, RSSI) for the cell(s) and/or satellite(s) by performing the variable measurement procedures instead of the general measurement procedures. For example, the preconfigured condition may be a case when cTimer is equal to or less than the cTimer threshold (e.g. T1), a case when cTimer is equal to or less than the cTimer threshold and sTimer exceeds the sTimer threshold (e.g. T2), a case when sTimer is equal to or less than the sTimer threshold, or a case when cTimer is equal to or less than the cTimer threshold and sTimer is equal to or less than the sTimer threshold.

Meanwhile, when the connection establishment procedure between the UE and the satellite 1 (e.g., cell 11) is completed, communication (e.g. downlink communication and/or uplink communication) between the UE and the satellite 1 may be performed (S902). The UE may operate (e.g. start) sTimer from a time it is connected to the satellite 1 (e.g. a time it accesses the satellite 1). The value of sTimer may be decreased according to the decrement interval. The UE may operate (e.g. start) cTimer from a time it is connected to the cell 11 of the satellite 1 (e.g. a time it accesses the cell 11). If the value of cTimer is less than or equal to T1, if the value of cTimer is less than or equal to T1 and the value of sTimer is greater than T2, if the value of sTimer is less than or equal to T2, or if the value of cTimer is less than or equal to T1 and the value of sTimer is less than or equal to T2, the UE may perform the variable measurement procedures. Alternatively, the UE may perform the general measurement procedures even if the above-mentioned condition is satisfied.

The UE may determine whether a handover event (e.g. intra-SAT handover event) occurs based on measurement results (e.g. received signal quality(ies)) for the cell(s). When a handover event occurs (e.g. when an event for a handover procedure from the cell 11 to the cell 12 occurs), the UE may transmit a handover (HO) initiation message to the cell 11 (e.g. serving cell) (S903). The HO initiation message may include information on the cell 12 that is a target cell. The cell 11 of the satellite 1 may receive the HO initiation message from the UE, and transmit a HO request message to the cell 12 that is the target cell (S904). The cell 12 of the satellite 1 may receive the HO request message from the cell 11, and determine whether to admit the handover procedure (e.g., intra-SAT handover procedure) based on the HO request message (S905).

When the handover procedure is approved, the cell 12 may transmit an HO request acknowledgment message to the cell 11 (S906). When the HO request acknowledgement message is received from the cell 12, the cell 11 may determine that the handover procedure to the cell 12 has been approved. In this case, the cell 11 may transmit an RRC reconfiguration message (e.g. HO command message) to the UE (S907). When the HO command message is received from the cell 11, the UE may determine that the handover procedure to the cell 12 has been approved. Therefore, the UE may perform a connection establishment procedure with the cell 12. In the connection establishment procedure, the cell 12 may signal intra-SAT handover configuration information and/or measurement configuration information for the cell 12 to the UE. The UE may receive the intra-SAT handover configuration information and/or measurement configuration information from the cell 12 and operate based on the received configuration information.

When the connection establishment procedure between the UE and the cell 12 is completed, communication (e.g. downlink communication and/or uplink communication) between the UE and the cell 12 may be performed (S909). The UE may operate (e.g. start) cTimer from a time it is connected to the cell 12 (e.g. a time it accesses the cell 12). If the value of cTimer is less than or equal to T1, if the value of cTimer is less than or equal to T1 and the value of sTimer is greater than T2, if the value of sTimer is less than or equal to T2, or if the value of cTimer is less than or equal to T1 and the value of sTimer is less than or equal to T2, the UE may perform the variable measurement procedures. Alternatively, the UE may perform the general measurement procedures even if the above-mentioned condition is satisfied.

The UE may determine whether a handover event (e.g. inter-SAT handover event) occurs based on measurement results (e.g. received signal quality(ies)) for the satellite(s). When a handover event occurs (e.g. when an event for a handover procedure from the satellite 1 to the satellite 2 occurs), the UE may transmit a HO initiation message to the cell 12 (e.g. serving cell) (S910). The HO initiation message may include information on the satellite 2 (i.e. cell 21 of the satellite 2) that is a target satellite. The cell 12 of the satellite 1 may receive the HO initiation message from the UE, and transmit a HO request message to the satellite 2 (e.g. cell 21) that is the target satellite (S911). The satellite 2 (e.g. cell 21) may receive the HO request message from the satellite 1 (e.g. cell 12), and determine whether to admit the handover procedure (e.g., inter-SAT handover procedure) based on the HO request message (S912).

When the handover procedure is approved, the satellite 2 (e.g. cell 21) may transmit an HO request acknowledgment message to the satellite 1 (e.g. cell 12) (S913). When the HO request acknowledgement message is received from the satellite 2, the satellite 1 (e.g. cell 12) may determine that the handover procedure to the satellite 2 has been approved. In this case, the cell 12 may transmit an RRC reconfiguration message (e.g. HO command message) to the UE (S914). When the HO command message is received from the cell 12, the UE may determine that the handover procedure to the satellite 2 has been approved. Therefore, the UE may perform a connection establishment procedure with the satellite 2 (e.g. cell 21). In the connection establishment procedure, the satellite 2 (e.g. cell 21) may signal intra-SAT handover configuration information, inter-SAT handover configuration information, and/or measurement configuration information to the UE. The UE may receive the intra-SAT handover configuration information, inter-SAT handover configuration information, and/or measurement configuration information from the satellite 2, and operate based on the received configuration information.

When the connection establishment procedure between the UE and the satellite 2 (e.g. cell 21) is completed, communication (e.g. downlink communication and/or uplink communication) between the UE and the satellite 2 may be performed (S916). The UE may operate (e.g. start) sTimer from a time it is connected to the satellite 2 (e.g. a time it accesses the satellite 2). The value of sTimer may be decreased according to the decrement interval. The UE may operate (e.g. start) cTimer from a time it is connected to the cell 21 of the satellite 2 (e.g. a time it accesses the cell 21 of the satellite 2). If the value of cTimer is less than or equal to T1, if the value of cTimer is less than or equal to T1 and the value of sTimer is greater than T2, if the value of sTimer is less than or equal to T2, or if the value of cTimer is less than or equal to T1 and the value of sTimer is less than or equal to T2, the UE may perform the variable measurement procedures. Alternatively, the UE may perform the general measurement procedures even if the above-mentioned condition is satisfied.

The methods according to the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

1. A method of a user equipment (UE), comprising:
receiving, from a first cell of a satellite, first handover configuration information including information on a first cell service timer indicating a time during which communication services can be provided by the first cell;
decreasing the first cell service timer according to a first decrement interval; and
in response to the decreased first cell service timer that is equal to or less than a first threshold, triggering an intra-satellite (intra-SAT) handover procedure.

2. The method according to claim 1, wherein the first handover configuration information further includes at least one of information on the first decrement interval or information on the first threshold.

3. The method according to claim 1, further comprising:
receiving, from the first cell of the satellite, second handover configuration information including information on a satellite (SAT) service timer indicating a time during which the communication services can be provided by the satellite; and
decreasing the SAT service timer according to a second decrement interval, wherein the decreased SAT service timer exceeds a second threshold.

4. The method according to claim 3, wherein the second handover configuration information further includes at least one of information on the second decrement interval or information on the second threshold.

5. The method according to claim 3, wherein the first cell service timer starts after the UE is connected to the first cell, and the SAT service timer starts after the UE is connected to the satellite.

6. The method according to claim 1, further comprising:
receiving, from the first cell of the satellite, variable measurement configuration information; and
in response to the decreased first cell service timer that is equal to or less than the first threshold, performing variable measurement procedures instead of general measurement procedures based on the variable measurement configuration information,
wherein a measurement periodicity for the variable measurement procedures is shorter than a measurement periodicity for the general measurement procedures.

7. The method according to claim 1, wherein the triggering of the intra-SAT handover procedure comprises:
in response to an event for a handover from the first cell to a second cell of the satellite that occurs, transmitting a handover initiation message including information on the second cell to the first cell; and
receiving a handover command message from the first cell.

8. The method according to claim 7, further comprising: performing a connection establishment procedure with the second cell, the connection establishment procedure including; receiving third handover configuration information including information on a second cell service timer of the second cell.

9. A method of a user equipment (UE), comprising:
receiving, from a first satellite, first handover configuration information including information on a first satellite (SAT) service timer indicating a time during which communication services can be provided by the first satellite;
decreasing the first SAT service timer according to a first decrement interval; and
in response to the decreased first SAT service timer that is equal to or less than a first threshold, triggering an inter-satellite (inter-SAT) handover procedure.

10. The method according to claim 9, wherein the first handover configuration information further includes at least one of information on the first decrement interval or information on the first threshold.

11. The method according to claim 9, further comprising:
receiving, from the first satellite, second handover configuration information including information on a cell service timer indicating a time during which the communication services can be provided by a cell of the first satellite; and
decreasing the cell service timer according to a second decrement interval, wherein the decreased the cell service timer is equal to or less than a second threshold

12. The method according to claim 11, wherein the second handover configuration information further includes at least one of information on the second decrement interval or information on the second threshold.

13. The method according to claim 9, further comprising:
receiving, from the first satellite, variable measurement configuration information; and
in response to the decreased first SAT service timer that is equal to or less than the first threshold, performing variable measurement procedures instead of general measurement procedures based on the variable measurement configuration information,
wherein a measurement periodicity for the variable measurement procedures is shorter than a measurement periodicity for the general measurement procedures.

14. The method according to claim 9, wherein the triggering of the inter-SAT handover procedure comprises:
in response to an event for a handover from the first satellite to a second satellite that occurs, transmitting a handover initiation message including information on the second satellite to the first satellite; and
receiving a handover command message from the first satellite.

15. The method according to claim 14, further comprising: performing a connection establishment procedure with the second satellite, the connection establishment procedure including: receiving third handover configuration information including information on a second SAT service timer of the second satellite.

16. A method of a first satellite, comprising:
transmitting, to a user equipment (UE), first handover configuration information including information on a first cell service timer indicating a time during which communication services can be provided by a first cell of the first satellite;
receiving, from the UE, a first handover initiation message for an intra-satellite (intra-SAT) handover procedure triggered based on the first handover configuration information; and
in response to approval of the intra-SAT handover procedure from the first cell to a second cell of the first satellite, transmitting a first handover command message to the UE.

17. The method according to claim 16, further comprising: performing a connection establishment procedure between the second cell and the UE, the connection establishment procedure including: transmitting second handover configuration information including information on a second cell service timer indicating a time during which communication services can be provided by the second cell to the UE.

18. The method according to claim 17, wherein the first cell service timer and the second cell service timer are configured independently.

19. The method according to claim 16, further comprising:
transmitting, to the UE, third handover configuration information including information on a satellite (SAT) service timer indicating a time during which communication services can be provided by the first satellite;
receiving, from the UE, a second handover initiation message for an inter-satellite (inter-SAT) handover procedure triggered based on the third handover configuration information; and
in response to approval of the inter-SAT handover procedure from the first satellite to the second satellite, transmitting a second handover command message to the UE.

20. The method according to claim 16, further comprising: transmitting variable measurement configuration information to the UE, wherein variable measurement procedures are performed by the UE instead of normal measurement procedures when a preconfigured condition is satisfied, and a measurement periodicity for the variable measurement procedures is shorter than a measurement periodicity for the general measurement procedures.
